(19) United States
(12) Patent Application Publication
(10) Pub. No.: US 2010/0153635 A1
(43) Pub. Date: Jun. 17, 2010

(54) Storage device with expandable solid-state memory capacity

(75) Inventors: Margot Ann LaPanse, Superior, CO (US); Michael Edward Baum, Longmont, CO (US); Stanton MacDonough Keeler, Longmont, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/337,187

(22) Filed: Dec. 17, 2008

(51) Int. Cl. G06F 12/02

(52) U.S. Cl. 711/104; 711/E12.005

(57) ABSTRACT

In a particular embodiment, a circuit device is disclosed that includes a first interface to a high speed data bus of a host system and a second interface coupled to a first data storage device. The circuit device further includes a solid-state storage device having a first solid-state data storage medium and having at least one expansion slot to receive at least one second solid-state data storage medium to expand a memory capacity of the solid-state storage device. The circuit device also includes a control circuit adapted to receive data from the host system via the first interface and to selectively write the received data to one of the first data storage device and the solid-state storage device.

### FIELD

The present disclosure relates generally to a storage device with an expandable solid-state memory capacity, and more particularly, but not by limitation, to a circuit that includes a controller to determine memory storage locations between an expandable solid-state memory, such as a flash memory with at least one flash memory expansion slot, and a disc storage media.

### BRIEF DESCRIPTION OF THE DRAWINGS

FIG. 1 is a block diagram of a particular illustrative embodiment of system including a memory control circuit adapted to selectively write data to at least one of an expandable solid-state memory and a disc storage media, such as a magnetic disc recording media;

FIG. 2 is a block diagram of a particular illustrative embodiment of a system including a memory controller with an expandable solid-state memory and having access to a disc storage media;

FIG. 3 is a flow diagram of a particular illustrative embodiment of a method of adapting to an expanded a solid-state memory capacity via the memory controller circuit; and

FIG. 4 is a flow diagram of a particular illustrative embodiment of a method of selectively writing data to at least one of a solid-state memory and a disc storage media.

### DETAILED DESCRIPTION OF ILLUSTRATIVE EMBODIMENTS

Hybrid storage devices are data storage devices that include two different data storage media. In a particular example, the hybrid storage device can have a disc storage media and a solid-state storage media. In another particular embodiment, the hybrid storage device can include a first solid-state memory device and a second solid-state memory device that have different memory characteristics. For example, the first solid-state memory device may consume less power than the second solid-state memory device. In another example, the first solid-state memory device may be faster than the second solid-state memory. In yet another example, the first solid-state memory device may have less storage capacity than the second solid-state memory device.

Some hybrid storage devices have the non-volatile solid-state memory designed into their printed circuit boards, which provide no opportunity to increase the size of the non-volatile solid-state memory without replacing the entire storage device. Some systems utilize hard disc data storage and have the non-volatile memory installed on the motherboard of the host system. In this instance, the operating system of the host system determines where data is stored (in the non-volatile solid-state memory or the hard disc). However, the operating system may not intelligently direct the data flow.

In a particular embodiment, a system is disclosed that includes a host system, a data storage device, and a printed circuit board that couples the data storage device to the host system. The host system can be a computing device, such as a computer, a personal digital assistant (PDA), a mobile telephone, another electronic device, or any combination thereof. The printed circuit board includes a non-volatile solid-state memory and one or more expansion slots to receive additional non-volatile solid-state memory devices to expand a storage capacity of the solid-state memory. The printed circuit board can communicate with the host system via a high speed host bus. Further, the printed circuit board includes a controller integrated circuit (IC) that includes logic to determine whether to store data received from the host either at the data storage device or at a solid-state memory. Further, the printed circuit board can be used within a system that includes a conventional data storage device (such as a disc drive storage system) to provide hybrid data storage device functionality and benefits. By providing expansion slots on the printed circuit board, the non-volatile solid-state memory capacity can be increased without replacing the storage device. Further, the logic of the printed circuit board is adapted to dynamically adjust to utilize available non-volatile solid-state memory devices.

In a particular illustrative embodiment, a circuit device is disclosed that includes a first interface to a high speed data bus of a host system and a second interface coupled to a data storage device. The circuit device further includes a solid-state storage device having at least one expansion slot to receive at least one additional solid-state memory device to expand a memory capacity of the solid-state storage device. The circuit device also includes a control circuit adapted to receive data from the host system via the first interface and to selectively write the received data to one of the data storage device and the solid-state storage device.

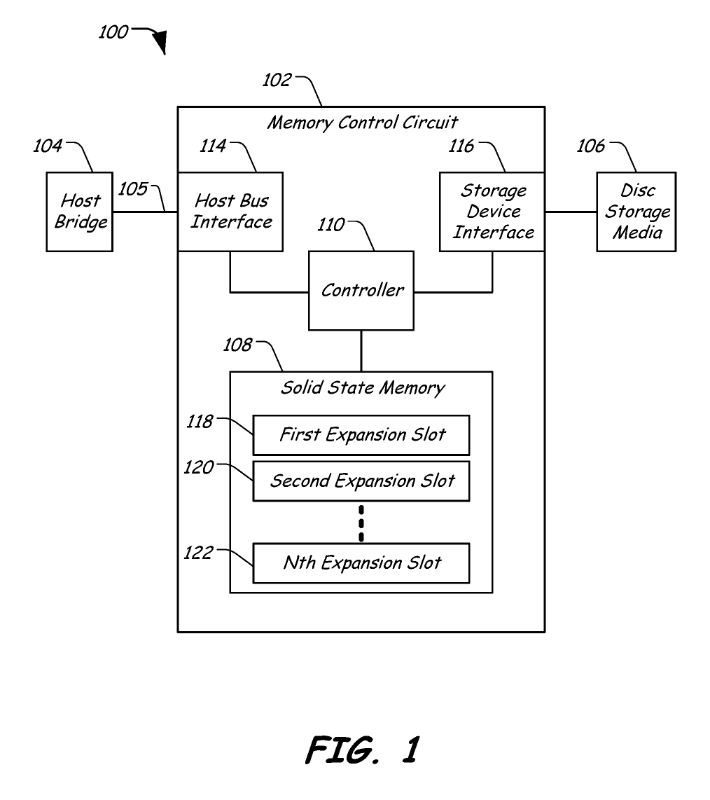

FIG. 1 is a block diagram of a particular illustrative embodiment of system 100 including a memory control circuit 102 adapted to selectively write data to at least one of an expandable solid-state memory and a disc storage media, such as a magnetic disc recording media. The system 100 includes a host bridge 104 that communicates with the memory control circuit 102 via a data bus 105. The system 100 further includes a disc storage media 106 that communicates with the memory control circuit 102. In a particular embodiment, the host bridge 104, the data bus 105, the memory control circuit 102, and the disc storage media 106 may be within a host system, such as a computer, a portable media player, a mobile telephone, a personal digital assistant, another computing device, or any combination thereof. In a particular embodiment, the memory control circuit 102 includes a solid-state memory module 108 that is non-volatile and that includes one or more expansion slots to receive additional flash memory devices to expand the data storage capacity of the solid-state memory module 108. In a particular embodiment, the solid-state memory module 108 can include flash memory, a magnetic random access memory (MRAM), a single or multi layer cell memory, another type of non-volatile solid-state memory, or any combination thereof.

The memory control circuit 102 includes a host bus interface 114 that is coupled to the data bus 105. The memory control circuit 102 further includes a controller 110 that is coupled to the host bus interface 114 and to the solid-state memory 108. The controller 110 is also coupled to a storage device interface 116, which is coupled to the disc storage media 106. In a particular embodiment, the storage device interface 116 can be a serial advanced technology attachment (SATA) interface to transfer data between the disc storage media 106 and the memory control circuit 102. In another particular embodiment, the storage device interface 116 can be a universal serial bus (USB) interface. In other implementations, different data transfer interfaces can also be used.

The solid-state memory 108 includes expansion slots, such as a first expansion slot 118, a second expansion slot 120, and an n-th expansion slot 122, which slots are adapted to receive solid-state memory devices to expand the data storage capacity of the solid-state memory 108. While only three expansion slots 118, 120, and 122 are shown, it should be understood that the solid-state memory 108 can include any number of expansion slots to provide increased storage capacity. The controller 110 is adapted to dynamically adjust to available memory at the solid-state memory 108 and to selectively utilize available data storage resources of both the solid-state memory 108 and the disc storage media 106.

In a particular embodiment, the memory control circuit 102 is adapted to determine a state of the system 100 and to selectively record data to the solid-state memory 108 based on the determined state. For example, when the system 100 is operating on battery power, the memory control circuit 102 can store data to the solid-state memory 108, allowing the system 100 to reduce power to the disc storage media 106. In another particular example, the memory control circuit 102 can pin frequently accessed files in the solid-state memory 108 to enhance performance of the system 100. In a particular example, the state of the system 100 can be determined by the controller 110 based on commands received via the host bus interface 114.

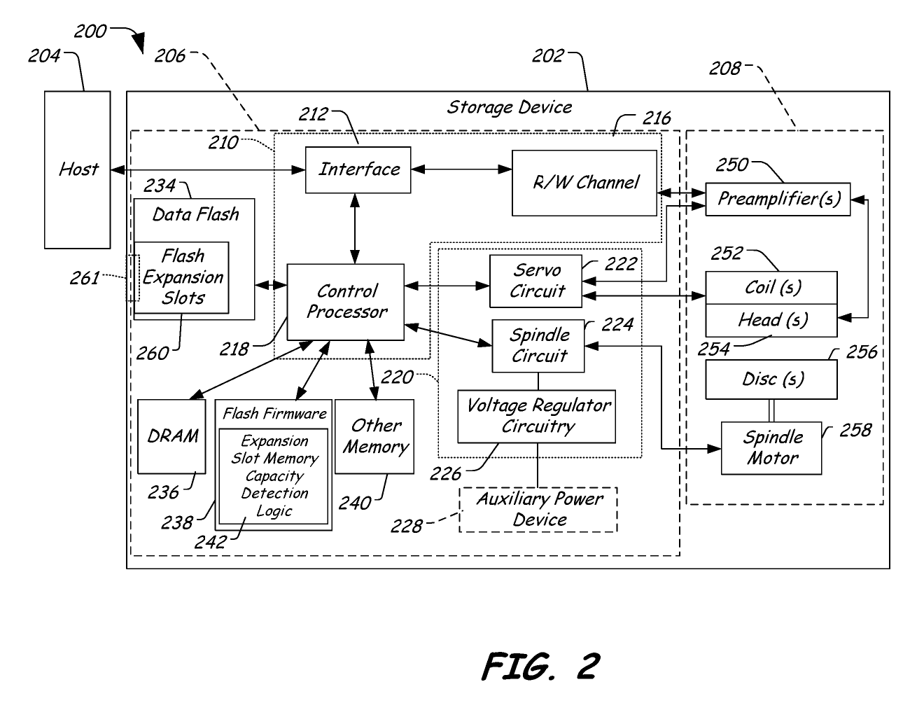

In an alternative embodiment, the expandable solid-state memory 108 can be incorporated into a data storage device (such as the data storage device 202 illustrated in FIG. 2), allowing a user to expand available the data storage capacity of the solid-state memory 108 as needed without having to replace the data storage device.

FIG. 2 is a block diagram of a particular illustrative embodiment of a system 200 including data storage device 202 with a memory controller 218, an expandable solid-state memory (such as a data flash) 234, a disc storage media 256. The hybrid storage device 202 includes both disc storage media (one or more discs 256) and solid-state storage media, such as a flash memory device (data flash 234, flash firmware 238, etc.). The hybrid storage device 202 is adapted to communicate with a host system 204. In a particular embodiment, the host system 204 can be a computer, a processor, a personal digital assistant (PDA), another electronic device, or any combination thereof. In a particular example, the hybrid storage device 202 can communicate with the host system 204 via a serial Advanced Technology Attachment (SATA) interface, a universal serial bus (USB) interface, another type of communication interface, or any combination thereof. In another particular example, the hybrid storage device 202 can be a stand-alone device that is adapted to communicate with the host system 204 via a network, such as via a network cable using a networking protocol.

The hybrid storage device 202 includes recording subsystem circuitry 206 and a head-disc assembly 208. The recording subsystem circuitry 206 includes storage device read/write control circuitry 210 and disc-head assembly control circuitry 220. The recording subsystem circuitry 206 further includes an interface circuit 212, which includes a data buffer for temporarily buffering data received via the interface circuit 212 and which includes a sequencer for directing the operation of the read/write channel 216 and the preamplifier 250 during data transfer operations. The interface circuit 212 is coupled to the host system 204 and to a control processor 218, which is adapted to control operation of the hybrid storage device 202.

The control processor 218 is coupled to a servo circuit 222 that is adapted to control the position of one or more read/write heads 254 relative to the one or more discs 256 as part of a servo loop established by the one or more read/write heads 254. The one or more read/write heads 254 can be mounted to a rotary actuator assembly to which a coil 252 of a voice coil motor (VCM) is attached. The VCM includes a pair of magnetic flux paths between which the coil 252 is disposed so that the passage of current through the coil 252 causes magnetic interaction between the coil 252 and the magnetic flux paths, resulting in the controlled rotation of the actuator assembly and the movement of the one or more heads 254 relative to the surfaces of the one or more discs 256. The servo circuit 222 is used to control the application of current to the coil 252, and hence the position of the heads 254 with respect to the tracks of the one or more discs 256.

The disc-head assembly control circuitry 220 includes the servo circuit 222 and includes a spindle circuit 224 that is coupled to a spindle motor 258 to control the rotation of the one or more discs 256. The hybrid storage device 202 also includes an auxiliary power device 228 that is coupled to voltage regulator circuitry 226 of the disc-head assembly control circuitry 220 and that is adapted to operate as a power source when power to the hybrid storage device 202 is lost. In a particular embodiment, the auxiliary power device 228 can be a capacitor or a battery that is adapted to supply power to the hybrid storage device 202 under certain operating conditions. In a particular example, the auxiliary power device 228 can provide a power supply to the recording subsystem assembly 206 and to the disc-head assembly 208 to record data to the one or more discs 256 when power is turned off. Further, the auxiliary power device 228 may supply power to the recording subsystem assembly 206 to record data to the data flash 234 when power is turned off.

Additionally, the hybrid storage device 202 includes the data flash memory 234, a dynamic random access memory (DRAM) 236, firmware 238 (such as a flash memory), other memory 240, or any combination thereof. In a particular embodiment, the firmware 238 is accessible to the control processor 218 and is adapted to store the expansion slot memory capacity detection logic instructions 242.

In a particular embodiment, the data flash memory 234 includes one or more flash expansion slots 260 that are adapted to receive a respective one or more flash memory devices to expand a data storage capacity of the data flash memory 234. In a particular embodiment, the one or more flash expansion slots 260 may be accessible via openings 261 corresponding to the one or more flash expansions slots 260 to insert additional flash memory devices into the storage device 202 to expand the data storage capacity of the data flash memory 234. Further, the control processor 218 is adapted to load the expansion slot memory capacity detection logic 242 from the flash firmware 238 and to execute the expansion slot memory capacity detection logic 242 to dynamically detect the presence of additional flash memory devices coupled to the flash expansion slots 260. The control processor 218 is adapted to dynamically adjust to the available storage capacity and to selectively write data to at least one of the data flash memory 234 (utilizing the detected available data storage capacity) or the one or more discs 256.

In a particular embodiment, the one or more discs 256 can be replaced with a second solid-state memory that has a different performance characteristic from the data flash memory 234. In a particular example, the data flash memory 234 may be faster and/or consume less power than the second solid-state memory, while the second solid-state memory can have a larger storage capacity than the data flash memory 234.

In a particular embodiment, once the control processor 218 loads and executes the expansion slot memory capacity detection logic 242, the control processor 218 can determine an available memory capacity associated with the data flash memory 234 and its associated flash expansion slots 260. The control processor 218 can then utilize available data storage capacity of the data flash memory 234 and the one or more discs 256 to selectively store data received from the host system 204 to one of the data flash memory 234 or the one or more discs 256. In a particular embodiment, a power savings algorithm may be executed by the control processor 218 to write data to the data flash memory 234 when an available power supply is a battery power supply. In another particular embodiment, the control processor 218 can utilize a write optimization algorithm that reorders data write operations to the one or more discs 256 by queuing data and associated write commands to the data flash memory 234, reordering the write commands to reduce seek distances between adjacent writes, and writing to the one or more discs 256 during periods of inactivity. In a particular example, the periods of inactivity correspond to periods when data read requests fall below an activity threshold. In another particular embodiment, the control processor 218 is adapted to delete duplicative data write operations before writing the data to the one or more discs 256. In still another embodiment, data and data write commands can be collected at the data flash memory 234 until the memory usage of the data flash memory 234 reaches a threshold, and then the control processor 218 can flush the stored data to the one or more discs 256.

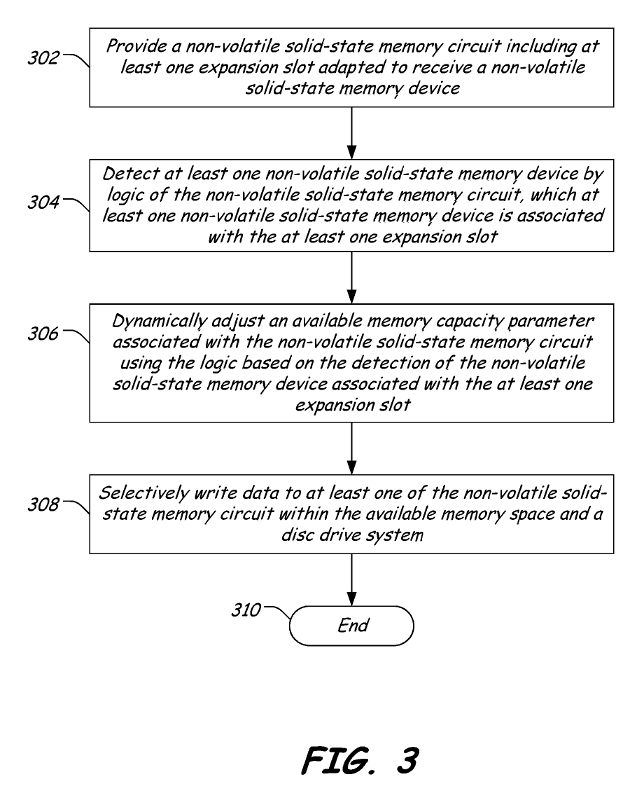

FIG. 3 is a flow diagram of a particular illustrative embodiment of a method of expanding a solid-state memory capacity via the memory controller circuit. At 302, a non-volatile solid-state memory circuit is provided that includes at least one expansion slot adapted to receive a non-volatile solid-state memory device. In a particular embodiment, the non-volatile solid-state memory circuit can be external to or incorporated within a storage device, such as a disc drive system. In an example where the non-volatile solid-state memory circuit is included within a disc drive device, the disc drive device may include at least one opening corresponding to the at least one expansion slot of the non-volatile solid-state memory circuit sized to receive a solid-state memory device. In a particular embodiment, the solid-state memory device can be a flash memory device.

Continuing to 304, at least one non-volatile solid-state memory device is detected by logic of the non-volatile solid-state memory circuit, which at least one non-volatile solid-state memory device is associated with the at least one expansion slot. In a particular embodiment, the non-volatile solid-state memory circuit can include a built-in solid-state memory and one or more expansion slots to expand the total data storage capacity of the non-volatile solid-state memory circuit via the addition of solid-state memory devices. Advancing to 306, an available memory capacity parameter associated with the non-volatile solid-state memory circuit is dynamically adjusted by the logic based on the detection of the non-volatile solid-state memory device associated with the at least one expansion slot. Proceeding to 308, data is selectively written via the logic to at least one of the non-volatile solid-state memory circuit within the available memory space and a disc drive system. In a particular example, the logic may apply a data storage command optimization algorithm to data and data write commands stored at the non-volatile memory circuit to reorder the data write operations. The logic can then execute the write operations in the new order to write data to the disc storage media of the disc drive system. The method terminates at 310.

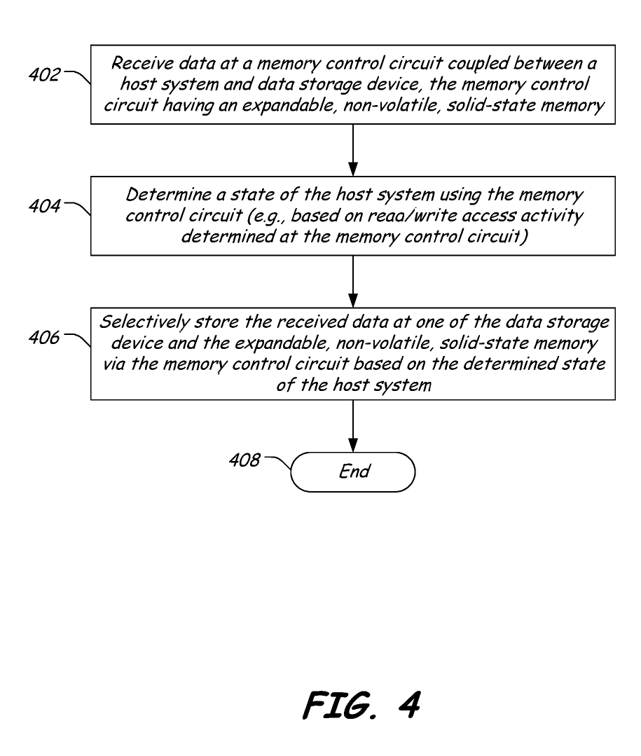

FIG. 4 is a flow diagram of a particular illustrative embodiment of a method of selectively writing data to at least one of a solid-state memory and a disc storage media. At 402, data is received at a memory control circuit coupled between a host system and data storage device, the memory control circuit having an expandable, non-volatile, solid-state memory. In a particular embodiment, the memory control circuit includes a non-volatile memory circuit having a first data storage capacity and includes at least one expansion slot to receive at least one additional solid-state memory device. By inserting at least one additional solid-state memory device into the at least one expansion slot, the memory control circuit can be adjusted to have a second data storage capacity that is greater than the first data storage capacity. Continuing to 404, a state of the host system is determined using the memory control circuit. In a particular embodiment, the state of the host system can be determined based on read/write access activity at the memory control circuit. Proceeding to 406, the received data is selectively stored at one of the data storage device and the expandable, non-volatile, solid-state memory via the memory control circuit based on the determined state of the host system. The method terminates at 408.

In conjunction with the systems and methods described with respect to FIGS. 1-4 above, a control circuit is disclosed that is adapted to selectively direct data to one of an expandable solid-state storage media and a second data storage device. The control circuit can include the expandable solid-state storage media and can include slots or connectors adapted to receive additional solid-state memory devices. The expandable solid-state storage media and the additional solid-state memory devices can be flash memory devices or other solid-state memory devices, depending on the particular implementation. The second data storage device can be a disc storage media, a second solid-state memory device, or any combination thereof. In a particular embodiment, the second solid-state memory device can be of a different memory type or can have different performance characteristics from the expandable solid-state storage media. Further, the control circuit can be coupled to a data bus of the host system and to an interface of the data storage device. In this instance, the control circuit can be external to the data storage device. In another embodiment, the control circuit can be incorporated into a hybrid data storage device that includes a solid-state memory with at least one expansion slot to expand a memory capacity of the solid-state memory. By allowing for expansion of the data storage capacity of the solid-state memory via insertion of solid-state memory devices into available expansion slots with the data storage device, the overall data storage capacity can be enhanced without having to replace the data storage device.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the memory control circuit and the data storage system while maintaining substantially the same functionality without departing from the scope and spirit of the present invention. In addition, although the preferred embodiment described herein is directed to an expandable non-volatile solid-state memory system for use in connection with a second memory device, it will be appreciated by those skilled in the art that the teachings of the present invention can be applied to data storage devices that include multiple available non-volatile memories including at least one expandable solid-state memory, without departing from the scope and spirit of the present invention.

What is claimed is:

1. A circuit device comprising:
a first interface to a high speed data bus of a host system;
a second interface coupled to a first data storage device;
a solid-state storage device including a first solid-state data storage medium and including at least one expansion slot to receive at least one second solid-state data storage medium to expand a memory capacity of the solid-state storage device; and
a control circuit adapted to receive data from the host system via the first interface and to selectively write the received data to one of the first data storage device and the solid-state storage device.

2. The circuit device of claim 1, wherein the data storage device comprises a hard disc drive.

3. The circuit device of claim 1, wherein the control circuit is included within the data storage device.

4. The circuit device of claim 1, wherein the control circuit is adapted to determine a power mode associated with the host system and to selectively write the data to one of the first solid-state data storage medium and the first data storage medium based on the determined power mode.

5. The circuit device of claim 4, wherein the control circuit writes the received data to the solid-state data storage device when the host system is operating on battery power according to the determined power mode.

6. The circuit device of claim 1, wherein the control circuit selectively writes portions of the received data to the solid-state data storage device and to the first data storage device, wherein a first portion of the received data represents frequently accessed data that is stored at the solid-state data storage media, and wherein a second portion of the received data is written to the first data storage device.

7. A storage device comprising:
an interface responsive to a host system;
a first data storage medium;
a solid-state data storage device comprising a solid-state data storage medium having at least one expansion slot to receive at least one second solid-state data storage medium to provide an expandable solid-state storage capacity; and
a control circuit adapted to communicate with the host system via the interface and to selectively store received data to at least one of the solid-state data storage device and the first data storage medium.

8. The storage device of claim 7, further comprising a housing including at least one opening associated with the at least one expansion slot to receive the at least one second solid-state data storage medium.

9. The storage device of claim 7, further comprising solid-state memory detection logic adapted to dynamically detect the at least one second solid-state data storage medium and to adjust an available memory parameter associated with the solid-state data storage device in response to detection of the at least one second solid-state data storage medium.

10. The storage device of claim 7, wherein the control circuit includes logic to selectively determine a data storage location associated with one of the solid-state data storage device and the first data storage medium according to a storage device performance parameter.

11. The storage device of claim 10, wherein the control circuit stores frequently accessed data at the solid-state data storage device to reduce access time for the frequently access data relative to retrieval times associated with the first data storage medium.

12. The storage device of claim 7, wherein the solid-state data storage device is attached to a printed circuit board that includes the control circuit.

13. The storage device of claim 7, wherein the first data storage medium comprises a hard disc drive.

14. A system comprising:
a processor adapted to process software instructions;
a first data storage medium; and
a memory control circuit coupled to the processor via a data bus and coupled to the data storage device, the memory control circuit comprising:
a solid-state data storage medium; and
at least one expansion slot to receive at least one second solid-state data storage medium to expand a storage capacity of the memory control circuit.

15. The system of claim 14, wherein the memory control circuit further comprises control logic adapted to receive data from the processor and to selectively store the received data to at least one of the first data storage medium and the solid-state data storage medium.

16. The system of claim 15, wherein the control logic is adapted to detect additional storage capacity associated with the at least one second solid-state data storage medium and to dynamically adjust an available memory parameter associated with the solid-state data storage medium to include the detected additional storage capacity.

17. The system of claim 15, wherein the memory control circuit selectively stores first data to the first data storage medium and second data to the solid-state data storage medium according to one of a data block size, a data access frequency, and an operating mode of the first data storage medium.

18. The system of claim 15, wherein the memory control circuit selectively stores received data to the solid-state data storage medium and flushes data from the solid-state data storage medium to the first data storage medium when the solid-state memory device capacity exceeds a threshold.

19. The system of claim 14, wherein the memory control circuit communicates with the processor via a high speed host bus and communicates with the first data storage medium via a storage device interface.

20. The system of claim 14, wherein the solid-state data storage medium comprises a flash memory device and wherein the at least one expansion slot allows for additional flash memory devices to expand the storage capacity of the solid-state data storage medium.
